(19) United States
(12) Patent Application Publication
(10) Pub. No.: US 2009/0208066 A1
(43) Pub. Date: Aug. 20, 2009

(54) Method for Recording and Visualising trainable performance Features and/or Characteristics

(76) Inventor: Hans-Diedrich Kreft, Dassendorf (DE)

Correspondence Address: Horst M. Kasper, 13 Forest Drive, Warren, NJ, 07059, US

(21) Appl. No.: 12/225,678

(22) PCT Filed: Feb. 27, 2007
(86) PCT No.: PCT/EP2007/001673

§ 371 Date: Mar. 16, 2009

(30) Foreign Application Priority Data
Feb. 27, 2006 (DE) 10 2006 009 470.0

(51) Int. Cl. G06K 9/00; G06T 11/20

(52) U.S. Cl. 382/113; 345/440.2

(57) ABSTRACT

The invention relates to a method by which means competence functions can be represented on the basis of defined, common data criteria and used in the Internet. The invention also relates to a process whereby appliances to be used by people are able to complete and modify the data records for competence functions in a computer-assisted manner, to the definition of criteria for the determination of virtual competences of programs, and to the way in which such programs can automatic change and improve.

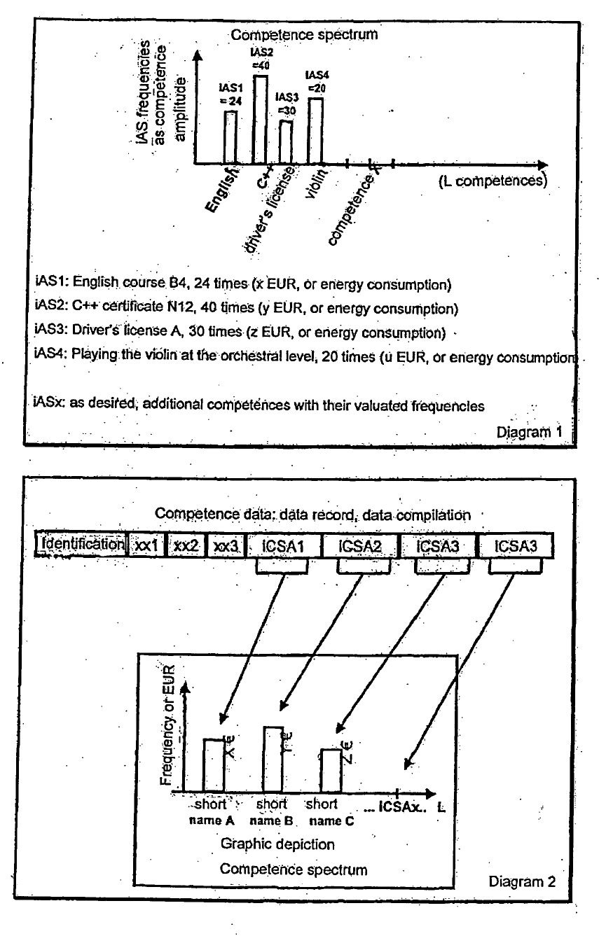

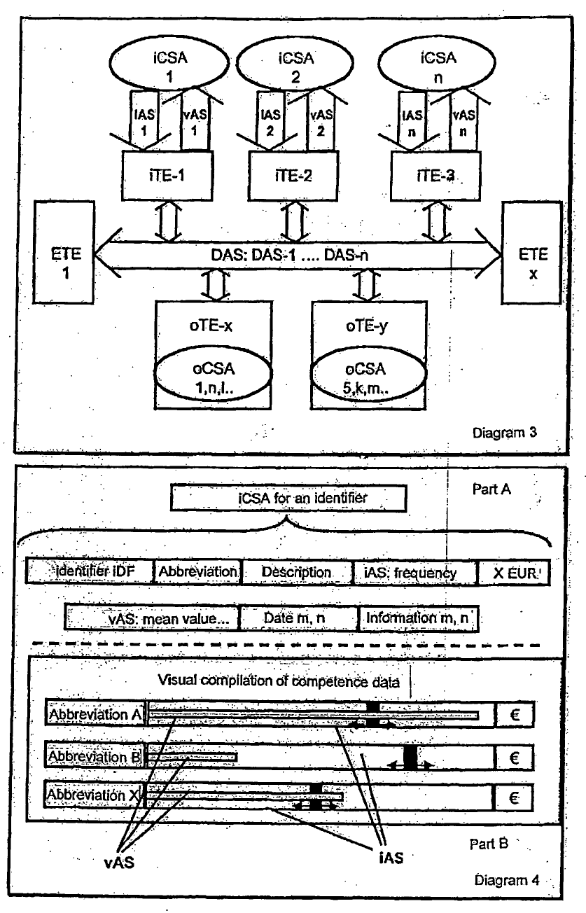

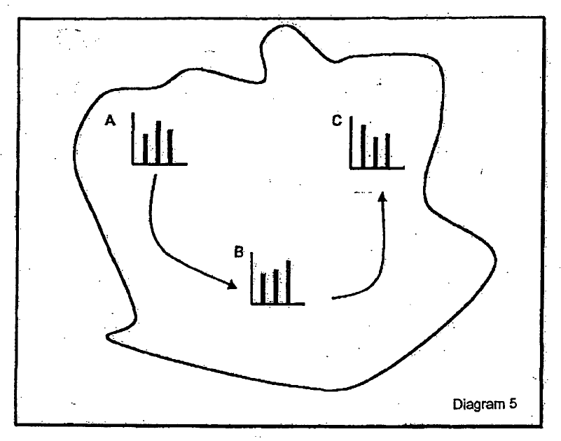

### TECHNICAL-COMMERCIAL FIELD

The invention relates to a method for recording, utilizing and depicting trainable human performance features and/or characteristics, namely, for uniformly generating and utilizing competence distributions on technical devices.

### STATE OF THE ART

The documents DE 101 29826 A1, PCT/EP01/07777, DE 103 49 271, DE 103 53 898, PCT/BP2004/011864, DE 103 58 958, PCT/EP2004/014197 disclose bar charts that associate monetary values (also monetary streams as amounts of money per unit of time) with products, performances or else human knowledge and skills. These documents also show how mathematical methods can be employed to obtain characteristic values from the bar charts.

Human, trainable characteristics, knowledge, skills and performance features are referred to here as competences. Insofar as competences can be distinguished from each other, they are treated as autonomous measured quantities which, like autonomous measured quantities in physics or technology, are incommensurable, that is to say, cannot be added to each other. In this respect, competences can be compared to measured quantities in technology. The difference is that every technical measured quantity has its individual unit of measurement that is determined by a measuring method (e.g. by the number of wavelengths of a given emission line in the case of the definition of a unit of length). Such measured quantities can only be determined for human physical performance features of the type encountered mainly in sports. When it comes to the wide array of musical or intellectual performances of people, it has not been possible to put forward measuring methods that satisfy technical criteria.

In the final analysis, a measured quantity indicates how often a unit occurs. For instance, the information “12 meters” indicates that the unit “meter” occurs twelve times. The number 12 can be interpreted as the frequency of the occurrence of the unit “meter”. In this context, competences can also be provided with frequency quantities. If, for example, 20 violinists are present in an orchestra, the competence of “playing the violin” is present 20 times. In this context, Diagram 1 depicts frequencies for a group of people. In the group, for instance, playing the violin at the orchestral level is present as a competence with the frequency iAS4=20 (i.e. 20 times). If a comparable approach is taken for other competences, diagrams like those in Diagram 1 can be depicted for many groups of people; these diagrams are comparable to frequency diagrams and are generally referred to here as competence distributions. If the competence distributions can be provided with units, this is referred to as amplitudes. Thus, for instance, the average total salary AS EUR of the musicians could be indicated as the basis of a unit, so that, for example, a monetary value of 20×AS EUR could be indicated as the amplitude value. This is depicted for several competences with the abbreviations A, B, C in Diagram 2. The energy consumption or heat radiation per musician could also be employed. In the final analysis, these are values expressed as the product of the frequency multiplied by the unit of measurement. In this multiplicative context, one speaks of scalable competence values. They are likewise referred to as iAS insofar as the factor between frequency and dimension (unit) is the same; see Diagram 1 or Diagram 2. The factors/multipliers can be any desired numbers or else operators (e.g. matrices, functions). Graphic depictions such as those shown in Diagram 1 are called competence spectra insofar as the dimensioning in the y-axis makes use of the same units. It is clear that the x-axis consists of an accumulation of incommensurable competences, as a result of which their linear arrangement there does not permit any mathematical comparison relations (as is otherwise the case for x-axes). It would be more precise for L competences to have an L-dimensional depiction in which each competence stands for a dimension.

### TASK AT HAND

It is the objective of the present invention to record different, trainable human performance features and/or characteristics on various technical devices in the form of data in such a way that it can be compared, and so that said data can be industrially utilized.

### Regarding Claim 1:

In order to achieve the objective, Claim 1 describes a method for recording, utilizing and depicting trainable human performance features and/or characteristics,
1) whereby data compilations iCSA are present on technical devices (iTE),
2) the iTE augment the iCSA with amplitude data (iAS),
3) the iAS are connected to other technical devices (ETE) via technical systems for data transport (DAS),
4) whereby the ETE store, process and link the iCSA from a plurality of technical devices iTE,
5) which results in verified data (vAS),
6) the vAS are available to the technical devices iTE via the DAS,
7) as a result of which the vAS are available as comparative values on the iTE,
8) so that, via systems for data transport DAS, the iCSA with the iAS and/or vAS are available on other technical systems oTE in any desired combination as data (oCSA) for display, checking, observation or manipulation purposes.

The method described in Claim 1 utilizes technical devices (iTE) in order to be able to determine and/or record trainable human performances as data, either individually or in a data compilation (also see Diagram 3). Such performances can be present as physical performances such as running, jumping and/or as mental performances such as playing chess or playing a musical instrument. They are present as incommensurable quantities and, as a whole, are referred to as competences. Data compilations that, in some manner, are to be associated with or connected to competences are referred to here by their abbreviation iCSA. The technical devices (iTE) can be training devices to determine and record sports and/or mental characteristics/performances. A special purpose of these devices is to associate the iCSA with amplitude data iAS such as is the case in the above-mentioned manner, for instance, in the form of frequencies. Sports performances can be additionally determined by means of physical measurements such as the time, height and weight. Mental performances such as playing chess, can be evaluated, for example, by means of computers. The evaluation based on the winning of competitions can also be recorded in the form of data. The iAS can either be automatically recorded by machines or else can be entered manually. Thus, for instance, the ranking in competitions or frequency information could be utilized as manually entered data iAS. The data can also be present in the form of certificates. The scoring of performances also constitutes usable data that can be employed as amplitude data iAS.

Competence data are connected to technical devices (ETE) via technical systems for purposes of data transport (DAS). An example of a system for data transport is the Internet. Systems whose usability is locally restricted can also be used for data transport and communication. ETE are preferably data-processing installations, for example, of the type known as servers. The ETE can link the data compilations iCSA with each other, for example, according to program commands or can perform computing operations on individual items of data, thus yielding linked or computed data. If iAS are linked by means of computing operations in that, for instance, a mean value is formed from a large quantity of iAS data that have been recorded on various systems iTE, then linked iAS data are present in the form of vAS. The vAS are referred to as verified amplitude data (vAS). These vAS can be fed again into the iTE via the system DAS. These are then available there, for example, as comparative values for the recording of the iAS.

By means of the systems for data transport DAS, any desired combination of the data compilations iCSA with their iAS, vAS can be transmitted to technical devices oTE. This is where any desired data or data combinations of the iAS and/or vAS can be combined at will, irrespective of the recording of data on the iTE. Thus, for instance, the evolution over time of various amplitude data iAS can be observed/checked over prolonged periods of time. Completely new data records that had not been compiled up until then can be configured in a way that seems practical for the users of the oTE.

Regarding Claim 2: Claim 2 lays claim to data compilations iCSA of individual human competences,
1) whereby each data compilation iCSA is associated with at least one unique identifier iDF,
2) as a result of which precisely one performance feature is characterized in the form of a competence,
3) whereby additional data such as abbreviation, description, value, date are associated with the identifier,
4) so that graphic depictions can be compiled from the data on technical systems iTE and/or oTE,
5) which, due to their depiction form, contain recognition features for humans,
6) so that data in different compilations can be compared by humans at different places using different technical systems.

According to Claim 1, human performance features iCSA are present as data compilations as shown in the example in Diagram 4, Part A. A specific competence is recorded in the form of data in that an identifier iDF is prescribed that is uniquely associated with a competence. This can be a combination of letters, numbers or characters that are only issued once internationally. Additional data are associated with the identifier, which especially includes abbreviations or brief descriptions (e.g. chess game ELO 1400 or English level 4). Descriptions pertaining to the recording or utilization of the data can also be associated with the iDF as text data. The iAS is recorded, for example, as a frequency, for which a monetary value in EUR or a monetary stream as EUR per unit of time can be indicated. The date (for instance, of the generation), the time of day, the oTE data and many other types of information such as, for instance, color stipulations for the depictions are all part of the data compilation that is to be recorded with an identifier. Ultimately, in this manner, a large amount of supplementary information can be associated with an identifier (and thus also with the competence), thus simplifying its use in relational databases. Consequently, a large volume of data is present that can be specifically employed in technical devices iTE or oTE. As a result, the performance features iCSA thus characterized are suitable to be comparatively depicted in tables or diagrams, so as to be once again recognizable by humans. This is shown symbolically in Diagram 4, Part B, where data from various identifiers from the top Part A are depicted in the bottom Part B so as to be visually comparable. Each appertaining depiction starts with the abbreviation, followed by a field depicting two bars and followed, in turn, by the field for the unit of the depiction (here EUR). The thin, darker bar can show, for example, data of the vAS type, while the thicker, lighter bar can show data of the iAS type. The length of the bars can be, for example, proportional to frequencies or monetary sums. If such a graphic depiction from the data of the iAS and/or vAS is possible, it can be clearly recognized by humans as a diagram and it contains a very specific message. In the case of Diagram 4, for instance, the message is that the competence with the abbreviation B has the shortest vAS value and the longest iAS value of the three characteristics, namely, abbreviation A, abbreviation B, abbreviation C. Therefore, Diagram 4 shows that certain forms of data compilations for competences at different places should be configured so as to be comparable in the form of tables or diagrams using different systems. Since all of the data are data relating to human characteristics, the resultant data compilations can be of the kind that did not occur in an individual person, but that could be found in a group of people. Here, one could speak of virtual characteristic compilations that are rendered visible in the form of a competence function insofar as the depiction in question was freely chosen and is not to be associated with any individual person.

Regarding Claim 3: in Claim 3, the data iAS and/or vAS
1) are made available for manipulation as desired by persons using technical devices iTE or oTE,
2) so that the iAS, vAS are available to the devices iTE, ETE, oTE in manipulated form via the DAS.

The technical devices iTE or oTE can be, for instance, those used for data processing (e.g. PCs). This is where data can be freely manipulated, that is to say, as desired, by persons in a wide array of manners. Thus, for example, data can be overwritten, augmented, reduced. By means of the features presented in Claim 1, said data are available in manipulated form to devices such as iTE, ETE, oTE.

The bottom part of Diagram 4 depicts data that are to be associated with an identifier; this is shown in the form of three bars arranged one below the other. The length of the bars constitutes scalable parts of data iAS or vAS. Data are scalable if they are present as numbers for which the known arithmetic computing operations apply. Diagram 4, Part B shows the bars depicting data of the type iAS, with thick black rectangles that are closed at the end. These bar ends can be moved with the cursor, for example, on the monitor of a computer (for instance, to the left or right as indicated by the small arrows). In this manner, the length of the bars of the iAS can be changed. The scalable data that are depicted by the length of the bars can thus be changed and recorded by the technical device for depicting and modifying graphic data, and then be made available for further processing on devices such as iTE, oTE, ETE.

Regarding Claim 4: In Claim 4, the data iAS and/or vAS are visually compiled in such a way
1) that various scalable data iAS and/or vAS are present as surface segments in one surface area,
2) whereby the surfaces are filled with colors or shades of gray,
3) whereby the overlapping of the colors and shades of gray yields graphic effects in the depiction of the surface segments.

Diagram 1, Part B shows how data iAS, vAS are visually compiled in surfaces configured as rectangles. The darker shades of gray in the depiction of the vAS overlap with the lighter ones of the iAS. In this manner, a graphic overlapping effect of the shades of gray or colors is achieved, whereby many other forms are also conceivable. Conclusions can be drawn on the basis of the overlapping.

Regarding Claim 5: In Claim 5, the data iAS and/or vAS are visually compiled in such a way
1) that structures shown three-dimensionally in graphic form are obtained,
2) whereby colors and shades of gray yield overlapping effects.

Three-dimensional structures are known on the level of graphic depictions. The data iAS, vAS can be utilized to depict such structures, whereby the use of different colors and shades of gray yields graphic overlapping effects comparable to a two-dimensional depiction.

Regarding Claim 6: In Claim 6,
1) the data iAS and/or vAS are compiled,
2) in that scalable parts are compiled with non-scalable parts.

Diagram 4, Part B shows the scalable parts as bars shaded in gray. The non-scalable parts such as abbreviation A, abbreviation B or the euro symbol [symbol] are entered there as well. Non-scalable characters occur in the form of letters, text or symbol compilations.

Regarding Claim 7: as a method, Claim 7 is characterized in that data iAS, vAS are augmented by data that establish an unambiguous, unique association of the data with an individual person.

The data iAS, vAS can be augmented by certain data records in order to associate them unambiguously and uniquely with a specific person. This could be, for example, an identity card number or passport number of a person. Biometric features of a person (e.g. the data record of a passport photograph, fingerprint data, voice characteristics, etc.) can likewise be included here. In this manner, it is ensured that two compilations of data in the form of competence spectra that appear to be graphically identical can be unambiguously associated with different people.

Regarding Claim 8: as a method, Claim 8 is characterized in that
1) part of the augmented data iAS, vAS as part of the iCSA constitutes a certification with which the presence of data is confirmed that stand for performance features in the iCSA for humans,
2) whereby the confirmation can be in the form of tests, achieving goals, taking tests, diplomas.

The knowledge and skills of people represented by the iAS, vAS in the iCSA can be augmented at will with data in any desired manner. This should be distinguished from data depicting performance features that are verifiably present or that were present at a certain point in time in the data compilations iCSA of a person. This can be done with supplementary data in the iAS, vAS, which are especially characterized in the form of a certification. Thus, the data can be depicted, for instance, as results of tests in the form of scores that are provided with another date that allows a review of the scores. This can be done, for example, by submitting the certification data to a certain institution that checks whether the certification data match the data at the institution. There are all kinds of methods known to experts that can be employed to test the authenticity of data. For instance, the certification data can be part of the numerical key whose other part is secured on a computer. Certified data compilations can also be securely stored on a central computer so that it can be checked whether data being used locally match the stored data.

Regarding Claim 9: as a method, Claim 9 is characterized in that certain data iAS, vAS, oCSA can only be used locally or on the Internet once a given numerical and/or alphanumeric code has been found to match data in the data record of the iAS, vAS, oCSA.

Under certain circumstances, the data iAS, vAS, oCSA should only be made accessible to certain persons. This can be done in that the local computer has an input keyboard and, only after a certain identification (e.g. numerical combination in the form of a PIN) has been entered, can the data be used that have the same identification. There can also be a reading station so that longer codes, for instance, of chip cards or other data media, can be read in. The identification can also be a photographic image of the user from which data are derived that match the data present in the iCSA, iAS, vAS, oCSA. Therefore, this data comparison can be a complete or partial match of biometric features.

Regarding Claim 10: as a method, Claim 10 is characterized in that
1) computers are employed to record characteristics, knowledge or skills as iCSA of people,
2) and in addition, certification data are automatically recorded and associated with the iAS, vAS.

Normally, the presence of knowledge or skills (competences) in individual persons is checked by teachers or examiners (qualified persons). Many of these tests can be transferred to suitable computers. If the presence of a competence in a person has been confirmed with computer-aided means, the appertaining identifier can be stored in the data record of a competence. Thus, for instance, the ability of playing chess at a certain qualification level can be tested by computer. Once it has been ensured that a given person is sitting at a computer, a series of chess games of a certain prescribed degree of difficulty can be played between the person and the computer. If the person wins the chess game with a certain quota, it is demonstrated that this person has a qualified ability to play chess in accordance with the given degree of difficulty. It is likewise conceivable for people to meet at a certain point in time in a room, where a supervisor identifies the players and monitors the proper progress of the game. If the ascertained iAS are provided, for example, with biometric features that can be recorded automatically, such as photographs of a person, or else automatically readable passport numbers, etc., the entire sequence for recording data pertaining to performance features as well as data pertaining to the certification can be effectuated automatically.

Even knowledge and skills that are complex to be learned such as, for instance, piloting an airplane, setting up control tables or playing works of music by notes can be tested by computer during the preparatory phase and can be subsequently automatically certified. This is particularly the case if the local computer is connected to suitable devices as is the case, for example, with flight simulators. Thus, it is conceivable that, in the future, there will be many different computer-aided devices for testing knowledge and skills, which concurrently unambiguously identify the person whose the performance data are being ascertained in the form of iAS, vAS. As an example, mention can be made here of sports equipment with which the precision and performance of a rower can be ascertained. The simulation device here is designed to be so similar to actual practice that it almost replicates the seat of an actual rowing shell. The simulation device ascertains several measured values that record the performance of the person, how precisely she/he handles the oar, etc. On the basis of the measured data, for example, a summary value can be determined for the performance and precision of action (timing of the turning and handling of the oar) on the part of the test person. In this context, unique data for identifying the person are concurrently provided.

Combinations of these data can function as description data for a competence and they enter into a competence function present for an individual person. On the basis of these data, the person can apply, for example, by means of the DAS, for an opening at a sports club that is looking for a suitable rower for its crew of eight. In this context, today's fitness centers can be viewed as precursors of “competence centers”. By including both the mental and musical performance features of humans, within a much broader scope, such centers will also contribute to the health and performance of people. This can be immediately seen if, instead of the rowing simulator, an electronic piano is employed by means of which the piano playing ability of a person is to be tested.

Since the type of test can be contained in the data record of the competence, differentiating between testing conducted by humans and testing conducted by computers does not pose any problems.

This type of competence tests entails the major advantage that many persons who do not have access to conventional educational opportunities (developing countries) or who are not in a position to dedicate the necessary time for this (homemakers) can use local computers in order to acquire the knowledge and skills that are generally accepted in the economy and in society and needed there.

In order for the above-mentioned new way of recording human knowledge and skills to be used in a computer-based manner so that the knowledge and skills are indeed recorded, it is necessary to have a wide array of rules to be observed by those wishing to learn. Thus, it is practical to provide standardized, reproducible devices and suitable environments (for example, exercise rooms). The details are not a subject matter of the patent. Here, the objective is to record competences employing computer-aided means in such a way that they can be stored in a certified manner in the data record iCSA of the competence function of a person.

Regarding Claim 11: as a method, Claim 11 is characterized in that
1) data pertaining to numerous individual competences are stored in a database,
2) so that said data can be used by local computers for their data records of competence functions.

In order for competence functions to be compared with each other, three criteria must be fulfilled. First of all, for each competence, there has to be an unambiguous description of its features such as its test criteria. Secondly, the competence has to be provided with a unique identifier iDF. Thirdly, a scalable value iAS must exist for every competence. If these three conditions are met in such a fashion that they are present in the form of data in a central database, then, on the basis of knowledge of the identifiers of a competence, local computers can download its description and/or associated monetary values or measured values, for instance, via the Internet and can use them, for example, in visual depictions.

Regarding Claim 12: as a method, Claim 12 is characterized in that
1) data pertaining to competences are to be entered using uniform forms,
2) whereby the forms are stored on the ETE and can be used via the DAS on the iTE as well as the oTE,
3) whereby the data recorded in the forms can be directly taken over into the data records of the iAS, vAS, oCSA by means of suitable programs,
4) and then stored in databases for external access.

Competences are also characterized by several types of data which, by means of the stipulations in the form, can be recorded in a standardized manner as input by people. Forms that are centrally stored in the ETE can be structured in a standardized manner. On the basis of the program, the data entered in the forms can be recorded and further processed directly as data of the iAS, vAS, oTE. The forms can be downloaded via the DAS using technical devices iTE, oTE and are generally available, for instance, via the Internet.

Regarding Claim 13: as a method, Claim 13 is characterized in that
1) data pertaining to the monetary valuation of competences in companies are recorded and continuously stored in a central database,
2) so that they can then be used by local computers iTE, oTE for their data records of competence functions.

If the economic value of competences is to be recorded, this information can be extracted from salaries and wages that companies pay for competences. In this manner, values for certain competences can be derived from the internal competence valuations of companies and these values are available for use by other computers via the DAS. This method is well-suited since companies that prevail in the competitive market over a prolonged period of time must have assessed the competences of their employees correctly. After all, many companies pay their employees on the basis of their competence. The competence values can be made available by companies independently of the employee data that are protected by privacy laws. Local computers can download the competence values and utilize them in data records of competence functions. This way, it is possible to provide competence functions for a large group of people in a comparable manner as is employed in companies. Values of competences can also be determined on the basis of data on supply and demand, similar to the way in which quotes on the stock exchange result from supply and demand. With this approach, it is possible, for example, to continuously use a local computer to follow the change over time of the valuation of a competence, in the same way as is done with the value of a stock.

Regarding Claim 14: as a method, Claim 14 is characterized in that
1) on the basis of programs, the scalable parts of the iAS data of competence functions are dependent on other iAS data that are to be depicted as data of a matrix,
2) as a result of which the amplitude values of the iAS depend on the compilation of the matrix data,
3) so that the competences continuously change as a function of the relations to other matrix data.

So-called perspective change is known from the specialized literature (see, for example, the journal “Personal” [Personnel], July/September 2005, published by Verlagsgruppe Handelsblatt, Düsseldorf, Germany, article titled “Controlling in Human Resource Management”, Kreft, van Gisteren). Thus, it is known that the values of competences are dependent on certain conditions under which they are utilized. These conditions can be depicted in matrix form (also in table form). It is thus possible, for instance, to ascertain that highly valued knowledge and skills to survive in the Kalahari desert are useless when it comes to surviving the traffic of a large, modern city. The interrelationships can result in the form of matrices containing numbers and values that depict the special conditions for the iAS. Thus, competence compilations in the various departments of companies can lead to a different valuation of an individual competence. For instance, the ability to speak Spanish might receive a high rating in a certain export department but lower in the development department, and so on. The relations between the iAS data on the basis of geographic data or company data can be determined by the program so that, depending on the matrix environment in which a competence function is present, its iAS values can be changed via the program.

Regarding Claim 15: as a method, Claim 15 is characterized in that
1) competence functions on the iTE are moved by positioning the cursor over imaged geographic regions,
2) whereby the depiction of the competence function changes as a function of the geographic position.

Diagram 5 symbolically shows a circumscribed geographic surface that appears on the monitor of a personal computer (PC). Competence functions are shown in simplified form at the sites A, B, C in the surface. This is supposed to be the same competence function consisting of the identical identifiers. The different levels of brightness and sizes of the bars are the result of a movement of the competence function over the geographic surface. The colors and sizes of the bars can change continuously if they are moved along the arrows from A to B to C. In this manner, it would be possible to see, for example, that the competence x in the Region A has a greater value than in Region C. On the basis of the program, the change can be made by means of matrix data according to Claim 14, said data being associated with the geographic regions.

Regarding Claim 16: as a method, Claim 16 is characterized in that
1) competence functions on the iTE are moved by positioning the cursor over imaged geographic regions,
2) whereby the depiction of the competence function changes as a function of the data regions.

Company-specific data regions comprise company data that can be depicted in tables (matrices). If a competence function is positioned over such tables, the appearance and data compilation of the competence function can change as a function of data compilation of the table. Thus, for instance, balance data (generally speaking controlling data) of companies can be generally seen as such table data. If the competence function (the competence spectrum) of a person from the development department is positioned by the movement of a cursor over, for example, the data of the competence functions of the sales department, a change occurs since the data records in the development department interact differently with the competence function than is the case with the data of the sales department. The visual depiction of the change can also be done in the form of numbers in tables that, in turn, can be depicted as controlling data.

Regarding Claim 17: as a method, Claim 17 is characterized in that
1) the data records iAS, vAS, oDS are compiled according to those of competence functions on the basis of requirements of the kind that are advantageous for solving tasks,
2) and these data records are stored on a central computer as requirement profiles for tasks,
3) so that they can be compared to those of competence functions of individual persons,
4) as a result of which it is possible to find certain persons who appropriately meet the requirement profiles.

The structure and set-up of data records can be configured in such a way that they can be derived from the requirements made by the task descriptions. This yields compilations/requirement profiles for companies that are suitable to solve the task at hand. In this manner, competences of the kind needed, for example, when the residents move out of a house, can be compiled in requirement profiles. If such a requirement profile is on hand, people can then use their individual competence functions to perform a comparison on a computer (e.g. of the ETE type) with the data of the requirement profile in order to ascertain, for instance, in how many competences they fulfill the competence requirements of the project. With this approach, companies could find suitable employees and employees could find jobs. It is likewise possible to employ mathematical methods for purposes of determining whether the data match various criteria.

Regarding Claim 18: as a method, Claim 18 is characterized in that the data iAS, vAS, oDS are associated with program agents on the Internet.

Programs referred to as agents are known in the realm of economics. These are programs that perform certain economically relevant tasks. Thus, for instance, stock exchange quotes are queried and gathered according to certain program stipulations; it is likewise possible to carry out Internet searches controlled by programs. These program agents can be augmented with data iAS, vAS, oDS, so that competence functions can also be associated with these agents. Consequently, these are data that have virtual, human-like properties.

Regarding Claim 19: as a method, Claim 19 is characterized in that
1) the data iCSA of competences are available in virtual worlds of the Internet and/or of the Web,
2) and can be linked to data of the virtual worlds.

On the Internet, virtual worlds are known where people assume a human-like identity and, in this manner, act as images in the virtual world. The human-like identities can be associated with data iCSA, iAS, vAS, oDS, so that the virtual individuals (persons) are equipped with competence functions in the virtual worlds as well. Thus, for example, programs can simulate the trainable characteristics of humans and lead to comparable data iAS, vAS, oDS in virtual worlds. The programs, in turn, can be provided with scalable properties. Thus, a virtual creature can be equipped with “physical” characteristics (comparable to sports characteristics in the real world) as well as “mental” characteristics, for instance, as chess players, whereby the ELO number indicates the level of the chess game.

Regarding Claim 20: as a method, Claim 20 is characterized in that
1) the iCSA, iAS, vAS, oDS serve to characterize program properties,
2) whereby the values generated in this manner are determined as virtual, scalable iASv, vASv of these program properties by means of tests and/or competitions,
3) so that the iASv, vASv stand for properties of programs rather than for human competences,
4) as a result of which data for competences are not associated with humans but rather with programs.

The iCSA, iAS, vAS, oDS are data that can be processed on computers and generated by computers. If these data were created in that characteristics and performance data were tested by programs, the result is data iASv, vASv for program performances that are formally comparable to those for the competences. This will be presented with reference to an example of chess programs. Chess programs can play against each other and in this manner, it can be determined which program wins more often. This is used to generate iASv or vASv data that are formally comparable to those of human chess players. This yields virtual competence characteristics iCSAv which, with their iASv, vASv, are comparable to the iCSA with their iAS, vAS.

Regarding Claim 21: as a method, Claim 21 is characterized in that
1) the values of the iAS, vAS can be autonomously changed by programs as scalable data,
2) in that in specific situations/perspectives, programs ascertain which program/program parts PT achieve certain results more frequently than other results,
3) whereby the program parts PT that reach certain frequencies are stored,
4) and are downloaded when a specific situation occurs.

Human competences can be trained and improved in this manner; this is reflected in the data iAS, vAS. The same applies to virtual competences iASv, vASv of programs or program parts PT. This will be illustrated once again on the basis of chess programs. Each chess situation can be interpreted as a specific perspective of a game of chess. Different programs can suggest different approaches, that is to say, chess moves, for different perspectives. These moves will be better or worse, depending on the program and perspective, in other words, some programs/program parts will achieve prescribed goals more often than others. So if a first program is better than a second one in a given perspective, then the program parts responsible for this can be incorporated into the second program. In other words, it is not the best chess move from a selection of moves in a concrete situation that is stored, but rather the program that turns out to be the strongest (most goal-oriented) more frequently when the situation occurs. This would give a compilation of programs that will be downloaded as a function of the position. Since the method can be largely automated, these are programs that can be trained by means of a program.

Regarding Claim 22: as a method, Claim 22 is characterized in that
1) the program parts PT are present in encapsulated form,
2) as a result of which the PT can be downloaded by various programs,
3) the PT are employed in a varying sequence.

Encapsulated programs are those that automatically execute certain functions when they are downloaded, since they have all of the fixed data and program parts available in order to execute their tasks. If they have standardized interfaces for the transfer of parameters, they can be downloaded by a wide array of programs and they execute their tasks using these parameters. If the PT are present in this form, they can be downloaded by a superordinated programmer or program (supervisor program) in a varying time sequence. This results in different program sequences. The supervisor programs can likewise employ the methods of the above-mentioned claims.

Regarding Claim 23: as a method, Claim 23 is characterized in that
1) supervisor programs download program parts PT,
2) which can be found on the Internet using the features of the Web,
3) and said supervisor programs can compile them for purposes of making a performance comparison.

Claim 22 discloses supervisor programs that use the PT in sequential compilations. Supervisor programs can be equipped with a search function in such a way that they find programs (program parts PT) on the Web that they can then compile for purposes of making a performance comparison.

### Description of Diagram 1:

A graphic embodiment of a competence spectrum (also competence function) is shown. The y-axis has the frequencies or their competence values as a multiplication of the frequency by the unit. The x-axis has iAS1, iAS2, iAS3, iAS4, . . . iASx as the abbreviated names of the values of competences. The depiction can be expanded for L competences. The x-axis has incommensurable data with which no larger or smaller relation can be associated. The depiction can apply to a group of people. In this case, the knowledge of the English language would be present 24 times. Correspondingly, the knowledge of playing the violin is present 24 times. It could also relate to a person whose income is distributed among the four competences as indicated by the heights of the bar. The bars in Diagram 1 can also be shown in the horizontal direction instead of in the vertical direction (see Diagram 4). They can also be depicted in the form of three-dimensional rods.

### Description of Diagram 2:

The top part symbolically shows a compilation of competence data as a data record. A data record can be considered as a linear or two-dimensional matrix arrangement of individual data. Here, for example, at the beginning of the data record, the identification is shown with which the data record for programs can be recognized as that for competence data. The symbols xx1, xx2, xx3 indicate augmentations of the data record that are not needed for the visual depiction of a competence function and that are available for various other purposes. It can be, for example, geographic information about the origin of the data. But it can also be information about whether the data have meaning as virtual data (data in program worlds) or in real, physical worlds. The sequential arrangement and placement of the data parts can be largely effectuated as desired. If the data are to be uniformly processed by programs, it is necessary to define their structure, in other words, a data protocol has to be established which can, for instance, be internationally standardized. The data protocol defines which feature is located where in a data record, also with which symbol it is to be characterized, etc. A protocol also has a description in natural language that indicates the relationship between the data (features) and the objects for which the data in the (real or virtual) worlds stand. The data iCS1 are part of the data record to which competences are to be associated in some specific manner. Thus, for instance, the frequency of a competence or its brief designation (abbreviation) can be connected with it. These data preferably appear in graphic depictions (bottom part of Diagram 2).

### Description of Diagram 3:

The top part shows the iCSA. These are data compilations that are to be associated with competences in some manner. The iAS, as part of the iCSA, are detected by the technical devices iTE as amplitudes of frequencies of competence performances and they are transmitted to the computer/server ETE via data-transmission systems DAS (such as, for example, the Internet or local data-transmission systems). The iCAS can be modified on the ETE. Thus, for instance, mean values can be obtained from the multitude of iAS present which are available to the iTE via the DAS as verified data vAS, where they can serve, for example, for comparison purposes. The iCSA are compiled and manipulated in any freely selectable form in the technical devices oCSA.

### Description of Diagram 4:

The top part symbolically shows the iCSA of which partial data are to be associated with an identifier iDF. These partial data preferably consist of the identifier, an abbreviation, a description of the partial data, the iAS, vAS, etc. Many types of other data can be associated with the identifier. These include monetary units, time of day and other information m, n.

The bottom part of Diagram 4 shows a visual compilation of competence data. These are 3 competences with the abbreviations A, B, X. The appertaining iAS are shown as thicker bars shaded gray while the vAS are shown as thinner bars in dark gray. Black rectangles are shown at the end of the iAS bars. If the cursor is moved, for example, over these regions on a monitor, the length of the iAS can be changed. The vAS, which represent, for instance, mean values, remain unaltered. They are changed by data transmissions DAS into the ETE and accordingly are only available in visual form. The right-hand side of the graph shows units (in this case, it is the monetary unit E).

### Description of Diagram 5:

A circumscribed geographic surface is symbolized. The places A, B, C there show a competence distribution (competence spectrum, competence function). Depending on the position (perspective), the data of the distribution change, which is shown in the change of the height of the bars or in their color change. The arrows indicate possible routes along which the distribution was moved on a monitor by a cursor.

### Information on the Terminology:

iCSA: this refers to data compilations that are to be associated with competences in some manner
iAS: this refers to amplitude data or competence performances that result from the multiplication of the frequency by the unit, whereby the descriptive relation to the frequencies is not necessarily required
iASv: this refers to virtual amplitude data that can be indicated as frequency for performance data of programs. The iASv correspond to the iAS.
vAS: this refers to verified amplitude data resulting from a computational/mathematical linking between different iAS.
vASv: this refers to virtual, verified amplitude data resulting from the iASv, in the same way as the vAS result from the iAS
iTE: this refers to technical devices that allow trainable human performances to be determined and/or recorded as data, either individually or in a data compilation
ETE: this refers to computers that are usually configured as servers
DAS: this refers to a system for data transmission (for example, the Internet or a local network)
oTE: this refers to computers that are connected to each other and to the ETE via the DAS and that can process the iCSA
oCSA: this refers to any freely selectable compilations of iCSA for display, checking, observation or manipulation purposes.

Another embodiment of the invention provides for a method for utilizing programs on a localizable computer that is connected to remote computers via the Internet for purposes of data exchange, whereby 1) data in a certain computer-independent arrangement are present on the localizable computer as a data record in protocolled form, 2) this data record receives a special data identification that characterizes it as a competence function, 3) a program can use the data record to graphically generate a competence function, 4) whereby the data record can be changed or augmented on the computer using a program on the basis of data that are entered by a person and/or that are present in the computer and/or that are accessible via the Internet, 5) so that, after the data record has been transmitted via the Internet to remote computers, competence functions can be graphically generated and modified there, likewise using a program.

In another embodiment of the invention, data for generating a competence function are augmented by data that do not serve for the graphic generation of the competence function, whereby the augmented data make it possible to associate a given competence function exclusively with a given person. A part of the augmented data of a competence function constitutes a certification with which competences are confirmed as performance features of persons. Certain competence functions can only be used locally or on the Internet after a match is present between a certain numerical and/or alphanumerical code and data in the data record of the competence function.

In another embodiment of the invention, computers are employed in order to record competences of persons, whereby the appertaining identifiers are stored in the data record of a competence function. In this context, data pertaining to numerous individual competences are stored in a database, so that they can be utilized by local computers for their data records of competence functions. The data can be recorded for purposes of evaluating competences in various companies and can be continuously stored in a central database, so that they can be used by local computers for their data records of competence functions. Here, data that determine the amount of the stored monetary values of their competences can be stored in the data record of competence functions.

In another embodiment of the invention, data records are compiled in accordance with those of the competence functions in a manner that is advantageous for solving tasks, and these data records are stored on a central computer so that they can be compared to those of competence functions.

### INDUSTRIAL APPLICABILITY

The invention is industrially applicable for a uniform generation and utilization of competence distributions on technical devices, especially for generating and utilizing competence distributions on the Internet.

1-32. (canceled)

33. A method for recording, observing, checking and utilizing human performance features and/or characteristics, characterized in that
1) local, technical devices serve to record human performances in the form of data or data compilations,
2) whereby numerous of these local, technical devices are connected to other central, technical devices such as computers or databases via technical systems, for purposes of data transport,
3) whereby the central, technical devices use the various local data by storing, processing or linking these data so as to centrally provide data for display, checking, observation or manipulation purposes,
4) whereby these centrally provided data are also made available to the local, technical devices via the systems for data transport,
5) so that the various, centrally generated data can be utilized or combined locally in new data compilations for purposes that are not given on the basis of the local data.

34. The method according to claim 33, characterized in that
1) the data iAS and/or vAS
2) are made available for manipulation as desired by persons using technical devices iTE or oTE,
3) so that the iAS, vAS are available to the devices iTE, ETE, oTE in manipulated form via the DAS.

35. The method according to claim 33, characterized in that
1) various scalable data iAS and/or vAS are present as surface segments in one surface area,
2) whereby the surfaces are filled with colors or shades of gray,
3) whereby the overlapping of the colors and shades of gray yields graphic effects in the depiction of the surface segments.

36. The method according to claim 33, characterized in that data with their scalable parts and with their non-scalable parts are compiled.

37. The method according to claim 33, characterized in that data compilations are augmented by data that establish an unambiguous, unique association of the data with an individual person.

38. The method according to claim 33, characterized in that
1) part of the augmented data constitutes a certification with which the presence of data is confirmed that stand for performance features in the iCSA for humans,
2) whereby the confirmation can be in the form of tests, achieving goals, taking tests, diplomas.

39. The method according to claim 33, characterized in that
1) computers are employed to automatically record characteristics, knowledge or skills as iCSA of people,
2) and in addition, certification data are associated.

40. The method according to claim 33, characterized in that
1) data pertaining to numerous individual competences are stored in a database,
2) so that said data can be freely combined and used for data compilations of competence functions, independently of the recording of data on local computers.

41. The method according to claim 33, characterized in that
1) data pertaining to competences are to be entered using uniform forms,
2) whereby the forms are stored on the ETE and can be used via the DAS on the iTE as well as the oTE,
3) whereby the data recorded in the forms can be directly taken over into the data records of the iAS, vAS, oCSA by means of suitable programs,
4) and then stored in databases for external access.

42. The method according to claim 33, characterized in that
1) data pertaining to the monetary valuation of competences in companies are recorded and continuously stored in a central database,
2) so that they can then be used by local computers iTE, oTE for their data records of competence functions.

43. The method according to claim 33, characterized in that
1) on the basis of programs, the scalable parts of the iAS data of competence functions are dependent on other iAS data that are to be depicted as data of a matrix,
2) as a result of which the amplitude values of the iAS depend on the compilation of the matrix data,
3) so that the competences continuously change as a function of the relations to other matrix data.

44. The method according to claim 33, characterized in that
1) competence functions on the iTE are moved by positioning the cursor over imaged geographic regions,
2) whereby the depiction of the competence function changes as a function of the geographic position.

45. The method according to claim 33, characterized in that
1) the data records iCSA and those related to them are compiled according to those of competence functions on the basis of requirements of the kind that are advantageous for solving tasks,
2) and these data records are stored on a central computer as requirement profiles for tasks,
3) so that they can be compared to those of competence functions of individual persons,
4) as a result of which it is possible to find certain persons who appropriately meet the requirement profiles.

46. The method according to claim 33, characterized in that
1) the iCSA, iAS, vAS, oDS serve to characterize program properties,
2) whereby the values generated in this manner are determined as virtual, scalable iASv, vASv of these program properties by means of tests and/or competitions,
3) so that the iASv, vASv stand for properties of programs rather than for human competences,
4) as a result of which data for competences are not associated with humans but rather with programs.

47. The method according to claim 33, characterized in that
1) the values of the iAS, vAS can be autonomously changed by programs as scalable data,
2) in that in specific situations/perspectives, programs ascertain which program/program parts PT achieve certain results more frequently than other results,
3) whereby the program parts PT that reach certain frequencies are stored,
4) and are downloaded when a specific situation occurs.

48. The method according to claim 33, characterized in that
1) supervisor programs compile program parts PT for search functions,
2) by means of which programs or program parts PT are found on the Web,
3) which are to be used for the compilation of data iCSA.
